(19) United States
(12) Patent Application Publication
(10) Pub. No.: US 2025/0326140 A1
(43) Pub. Date: Oct. 23, 2025

(54) HAIR-CUTTING UNIT WITH HAIR-ENTRY SLOTS HAVING A HAIR-RETAINING STRUCTURE

(71) Applicant: KONINKLIJKE PHILIPS N.V., EINDHOVEN (NL)

(72) Inventors: EELCO GALESTIEN, DRACHTEN (NL); JELLE KRIJTHE, DRACHTEN (NL); MARTIN CUPERUS, HARLINGEN (NL)

(21) Appl. No.: 18/861,948

(22) PCT Filed: Apr. 26, 2023
(86) PCT No.: PCT/EP2023/060924

§ 371 Date: Oct. 31, 2024

(30) Foreign Application Priority Data
May 5, 2022 (EP) 22171841.4

(51) Int. Cl. B26B 19/14

(52) U.S. Cl. CPC B26B 19/143; B26B 19/141

(57) ABSTRACT

A hair-cutting unit (9a) comprises an external cutting member (11a) and an internal cutting member (13a) rotatable relative to the external cutting member about a central axis. The external cutting member comprises hair-entry slots (35) having a slot angle (α) in a range from 0° to 20° in each radial position of the hair-entry slot. The internal cutting member comprises cutting elements (59a, 59b, 59c) each having a cutting edge (45a, 45b, 45c) having a cutting-edge angle (β) in a range from 55° to 85°. A trailing edge (43) of each hair-entry slot is provided with a hair-retaining structure (47) having an array of hair-abutment surfaces (53) extending transversely relative to the trailing edge and facing the central axis (19).

### FIELD OF THE INVENTION

The invention relates to a hair-cutting unit comprising a central axis, an external cutting member and an internal cutting member which is covered by the external cutting member and rotatable relative to the external cutting member about the central axis, wherein:
the external cutting member comprises a plurality of hair-entry slots that each extend, relative to the central axis, from a radially inner slot-end position to a radially outer slot-end position along a longitudinal extension of the hair-entry slot;
the internal cutting member comprises a plurality of cutting elements that each have a cutting edge;
a slot angle of each hair-entry slot, when seen in an axial direction parallel to the central axis, is defined as a sharp angle enclosed by a trailing edge of the hair-entry slot, relative to a rotational direction of the internal cutting member and extending along the longitudinal extension of the hair-entry slot, and a local radial direction, relative to the central axis, at said trailing edge; and
a cutting-edge angle of each cutting edge, when seen in the axial direction, is defined as a sharp angle enclosed by the cutting edge and a local radial direction, relative to the central axis, at said cutting edge, said cutting-edge angle being in a range from 55° to 85°.

The invention further relates to a shaving unit having at least one hair-cutting unit as described here before and further having a supporting structure configured to support the at least one hair-cutting unit.

The invention further relates to a shaving device having a main housing and a shaving unit as described here before coupled to the main housing, wherein the main housing accommodates a driving system configured to drive the internal cutting member of each hair-cutting unit of the shaving unit into rotation relative to the external cutting member.

### BACKGROUND OF THE INVENTION

A hair-cutting unit comprising an external cutting member and an internal cutting member which is covered by the external cutting member and rotatable relative to the external cutting member about a central axis of the hair-cutting unit is well known. Such a hair-cutting unit may be part of a shaving unit of an electric shaving device. The shaving unit may have two or more of such hair-cutting units supported by a supporting structure of the shaving unit. The shaving device may have a main housing accommodating an electric motor. The shaving unit may be coupled to the main housing in a permanent way or in a releasable way. When the shaving unit is coupled to the main housing, the motor is coupled to the internal cutting members of the hair-cutting units via a transmission system allowing the motor to rotate the internal cutting members relative to the external cutting members. During rotation of the internal cutting members, hairs may penetrate into the external cutting members via the hair-entry slots of the external cutting members and may be cut by interaction of the cutting edges of the cutting elements of the rotating internal cutting members and counter cutting edges formed on the trailing edges of the hair-entry slots of the external cutting members. The trailing edges of the hair-entry slots of an external cutting member are to be understood as being defined relative to the rotational direction of the internal cutting member associated with the external cutting member. I.e., during rotation of the internal cutting member a cutting edge of a cutting element of the internal cutting member will first pass a leading edge of the hair-entry slot and will subsequently pass the trailing edge of the hair-entry slot.

The hair-entry slots of the external cutting member generally extend, relative to the central axis, from a radially inner slot-end position to a radially outer slot-end position along a longitudinal extension of the hair-entry slot. In known hair-cutting units the hair-entry slots may be straight or curved and may have a main direction of extension in a radial direction relative to the central axis. Examples of hair-cutting units wherein the hair-entry slots have V-shaped portions are also known. In general, when seen in an axial direction parallel to the central axis, a slot angle of the hair-entry slot, in a predefined radial position at the hair-entry slot, may be defined as a sharp angle enclosed by the trailing edge of the hair-entry slot, which extends along the longitudinal extension of the hair-entry slot, and a local radial direction, relative to the central axis, at said predefined radial position at the hair-entry slot. In known hair-cutting units the slot angle may be constant or may vary over the full extension of the hair-entry slot.

In known hair-cutting units the cutting elements of the internal cutting member may be arranged on a carrier of the internal cutting member in one or more annular arrays about the central axis, and the cutting edges of the cutting elements may be straight or curved and may have a main direction of extension in the radial direction. Examples of hair-cutting units wherein the cutting edges of the internal cutting member have V-shaped portions are also known. In general, when seen in the axial direction, a cutting-edge angle of the cutting edge of each cutting element, in a predefined radial position at the cutting edge, may be defined as a sharp angle enclosed by the cutting edge and a local radial direction, relative to the central axis, at said predefined radial position at the cutting edge. In known hair-cutting units the cutting-edge angle may be constant or may vary over the radial extension of the cutting edges of the internal cutting member.

A known problem of hair-cutting units of a kind as described here before is so-called excessive skin doming, i.e., the skin of the user may bulge too much into the hair-entry slots of the external cutting member. While a certain degree of skin doming is necessary to achieve a sufficient degree of closeness of the hair-cutting process, excessive skin doming may lead to contact of the skin with the rotating internal cutting member, which may cause skin irritation or skin damage. Excessive skin doming may occur when the user places the shaving unit on the skin with too much pressure. To reduce skin doming and the resulting skin irritation. WO 2019/211128 proposes a hair-cutting unit of a kind as described here before wherein the slot angle of the hair-entry slots of the external cutting member is in a range from 35° to 60°. With such a relatively large slot angle it was observed that skin doming is significantly reduced or even avoided. To sufficiently prevent displacements of the hairs in the hair-entry slots by the cutting elements of the rotating internal cutting member (hair manipulation) and to achieve sufficient hair-cutting performance. WO 2019/211128 proposes, in combination with said relatively large slot angle, a relatively small shearing angle, in a range between 0° and 15°, between the cutting edges of the internal cutting member and the counter cutting edges on the trailing edges of the hair-entry slots of the external cutting member. In an embodiment disclosed in WO 2019/211128 both the cutting edges of the internal cutting member and the counter cutting edges of the external cutting member are straight, so that the shearing angle between the cutting edges and the counter cutting edges is constant over the full extensions of the cutting edges and the counter cutting edges. Although the hair-cutting unit of WO 2019/211128 thus combines a sufficient hair-cutting performance with relatively low degrees of skin irritation and hair manipulation, a disadvantage of this known hair-cutting unit is that the relatively large slot angle of the hair-entry slots reduces the hair-catching performance of the hair-cutting unit as compared with hair-cutting units wherein the hair-entry slots have a small slot angle and, thus, have a more radial extension relative to the central axis of the hair-cutting unit. The hair-catching performance relates to the degree of case at which hairs can penetrate into the hair-entry slots of the external cutting member during use.

### SUMMARY OF THE INVENTION

It is an object of the present invention to provide a hair-cutting unit of a kind as described here before in the section “field of the invention”, which provides a degree of skin irritation which is at least comparable to or lower than the degree of skin irritation provided by the hair-cutting unit of WO 2019/211128 and a hair-cutting performance which is at least comparable to or better than the hair-cutting performance of the hair-cutting unit of WO 2019/211128, but which has a significantly better hair-catching performance than the hair-cutting unit of WO 2019/211128.

To achieve the above-mentioned object, the present invention provides a hair-cutting unit comprising a central axis, an external cutting member and an internal cutting member which is covered by the external cutting member and rotatable relative to the external cutting member about the central axis. wherein:
the external cutting member comprises a plurality of hair-entry slots that each extend. relative to the central axis, from a radially inner slot-end position to a radially outer slot-end position along a longitudinal extension of the hair-entry slot;
the internal cutting member comprises a plurality of cutting elements that each have a cutting edge;
a slot angle of each hair-entry slot, when seen in an axial direction parallel to the central axis, is defined as a sharp angle enclosed by a trailing edge of the hair-entry slot, relative to a rotational direction of the internal cutting member and extending along the longitudinal extension of the hair-entry slot, and a local radial direction, relative to the central axis, at said trailing edge;
a cutting-edge angle of each cutting edge, when seen in the axial direction, is defined as a sharp angle enclosed by the cutting edge and a local radial direction, relative to the central axis, at said cutting edge, said cutting-edge angle being in a range from 55° to 85°;
the slot angle of each hair-entry slot along the longitudinal extension of the hair-entry slot is in a range from 0° to 20° in each radial position of the hair-entry slot between the radially inner slot-end position and the radially outer slot-end position; and
the trailing edge of each hair-entry slot is provided with a hair-retaining structure having an array of hair-abutment surfaces arranged along the trailing edge, each hair-abutment surface extending transversely relative to the trailing edge and facing the central axis.

A hair-cutting unit according to the present invention thus combines a relatively large cutting-edge angle of the cutting edges of the internal cutting member in a range from 55° to 85° with a relatively small slot angle of the hair-entry slots of the external cutting member in a range from 0° to 20°. This combination results in a relatively large angle enclosed by the trailing edges of the hair-entry slots and the cutting edges of the internal cutting member. The relatively small slot angle of the hair-entry slots in the range from 0° to 20° results in a significant improvement of the hair-catching performance of the hair-cutting unit as compared with the hair-cutting unit of WO 2019/211128.

The provision of the hair-retaining structure, having the array of hair-abutment surfaces arranged along the trailing edge of the hair-entry slot, results in the following technical effect. During operation, a hair that penetrates into a hair-entry slot will be manipulated by a cutting element of the rotating internal cutting member into a position in abutment with one of the hair-abutment surfaces of the hair-retaining structure that extend transversely relative to the trailing edge of the hair-entry slot. The hair-abutment surface will prevent further manipulation of the hair in the hair-entry slot by the cutting element during the subsequent hair-cutting process. As a result of the relatively large cutting-edge angle. the cutting edge of the rotating internal cutting member will make a slicing motion through the hair during the hair-cutting process, with the hair being held in a stationary position relative to the trailing edge by the hair-abutment surface. Said slicing motion results in an improved hair-cutting performance as compared with hair-cutting units wherein the hair-entry slots of the external cutting member and the cutting edges of the internal cutting member both have a main direction of extension in the radial direction relative to the central axis and wherein, as a consequence, the cutting edges make chopping motions through the hairs. Said slicing motion further results in a lower degree of wear of the cutting edges of the internal cutting member.

A further insight provided by the invention is that the hair-abutment surfaces, as a result of their extension in a direction transverse to the trailing edge of the hair-entry slot, and the trailing edge itself do not need to be provided with a counter cutting edge. The function of the hair-abutment surfaces is merely to maintain the hairs in a stationary position in the hair-entry slot during the hair-cutting process, while the slicing motion of the cutting edges of the internal cutting member through the hair suffices to effectively cut through the hair. The absence of any counter cutting edges on the external cutting member simplifies the manufacturing process of the external cutting member.

5 The relatively large cutting-edge angle of the cutting edges of the internal cutting member also limits the degree of skin irritation, in particular in combination with the presence of the hair-retaining structure at the trailing edge of the hair-entry slots. Said limited degree of skin irritation allows a relatively large degree of skin doming into the hair-entry slots. Consequently, the hair-entry slots may have a relatively large width, which will further improve the hair-catching performance of the external cutting member.

It is to be noted that, although in the description and claims the cutting-edge angle and the slot angle are both defined as having a positive value in, respectively, the range from 55° to 85° and the range from 0° to 20°. the cutting-edge angle and the slot angle may each have either a positive or a negative orientation with respect to the local radial direction at, respectively, the cutting edge and the trailing edge, seen in the axial direction.

In an embodiment of the hair-cutting unit according to the invention, a shearing angle enclosed by each hair-abutment surface, when seen in the axial direction, and the cutting edge of each of the cutting elements at said hair-abutment surface is in a range from 0° to 15°. With said shearing angle being in this range, the hairs are optimally maintained in a stationary position in the hair-entry slots by the hair-abutment surfaces of the hair-retaining structure during the hair-cutting process. More preferably, said shearing angle is in a range from 0° to 5°. In particular, the hair-abutment surfaces may each extend substantially parallel to the cutting edge of each of the cutting elements when present at the hair-abutment surface.

In a further embodiment of the hair-cutting unit according to the invention, the cutting-edge angle is in a range from 70° to 80°. With the cutting-edge angle being in this range, a relatively small angle in a range between 10° and 20° is enclosed by the cutting edges and a local direction of motion of the cutting edges at the hair-entry slots, which is tangentially relative to the central axis. This results in a particularly low degree of skin irritation, while cutting of the hairs by the slicing motion of the cutting edges through the hairs is very effective.

In a preferred embodiment of the hair-cutting unit according to the invention, the slot angle is in a range from 0° to 5°. With the slot angle being in this range, the hair-catching performance of the hair-cutting unit is further improved.

In a practical embodiment of the hair-cutting unit according to the invention, the hair-retaining structure comprises an array of tooth-like elements arranged along the trailing edge of at least one of the hair-entry slots, wherein the hair-abutment surfaces are each formed by a first side-edge surface of a respective one of the tooth-like elements facing the central axis. Thus, the hair-retaining structure may have a comb-like structure provided on the trailing edge. A hair that penetrates into the hair-entry slot will be manipulated by a cutting element of the rotating internal cutting member into one of the spaces that are present between the successive pairs of adjacent tooth-like elements and will be cut by the cutting element while being in abutment with said first side-edge surface of one of the tooth-like elements bounding said space. By providing a relatively large number of tooth-like elements along the trailing edge, the hair-retaining performance of the hair-retaining structure during the hair-cutting process may be optimized. A second side-edge surface of each respective tooth-like element facing away from the central axis may extend substantially parallel to the first side-edge surface of the respective tooth-like element. This will optimize the hair-catching performance of the hair-retaining structure provided along the trailing edge.

In an embodiment of the hair-cutting unit according to the invention, a leading edge. relative to the rotational direction of the internal cutting member, of the hair-entry slot extends as a straight line from the radially inner slot-end position to the radially outer slot-end position at a distance from the tooth-like elements. In this embodiment the hair-entry slot has a first area that extends as a continuous open slot area along the leading edge from the radially outer slot-end position to the radially inner slot-end position, and a second area along the trailing edge wherein the array of tooth-like elements of the hair-retaining structure is arranged. In this embodiment, hairs may be effectively caught initially in said first area of the hair-entry slot and may subsequently be efficiently manipulated by the cutting elements of the rotating internal cutting member into said second area of the hair-entry slot to be hold in position by the tooth-like elements of the hair-retaining structure.

In another embodiment of the hair-cutting unit according to the invention, a leading edge. relative to the rotational direction of the internal cutting member, of the hair-entry slot comprises a further hair-retaining structure having an array of further tooth-like elements arranged along the leading edge, each further tooth-like element having a further hair-abutment surface formed by a side-edge surface of the further tooth-like element extending transversely relative to the leading edge and facing the central axis. In this embodiment, hairs may also be cut while being in abutment with the further hair-abutment surfaces of the further tooth-like elements of the further hair-retaining structure provided along the leading edge of the hair-entry slot. Although the presence of the further tooth-like elements in the hair-entry slot might slightly decrease the overall hair-catching performance of the hair-entry slot, the overall hair-retaining performance of the hair-entry slot during the hair-cutting process is improved by the presence of the further hair-retaining structure. In this embodiment, the tooth-like elements of the hair-retaining structure of the trailing edge of the hair-entry slot and the further tooth-like elements of the further hair-retaining structure of the leading edge of the hair-entry slot may be mutually arranged in a staggered configuration and, seen in the radial direction, in a partially overlapping configuration. As a result, an open slot area between the hair-retaining structure of the trailing edge and the further hair-retaining structure of the leading edge may extend zigzag-like from the radially outer slot-end position to the radially inner slot-end position. This will significantly increase the overall hair-retaining performance of the hair-entry slot during the hair-cutting process.

In a particular embodiment of a hair-cutting unit according to the invention, a ratio of a first radial distance between the radially inner slot-end position and the central axis and a second radial distance between the radially outer slot-end position and the central axis is between 0.4 and 0.8. In practice the radially outer slot-end position may be at or very close to an outer circumference of the external cutting member. Thus, in this particular embodiment the hair-entry slots may extend over a significant part, i.e., between about 20% and about 60%, of the radius of the external cutting member. This will result in a relatively high hair-catching performance of the hair-entry slots. A preferred range for said ratio is between 0.5 and 0.6, which in practice may imply that the hair-entry slots extend over a radial distance of between about 40% and about 50% of the radius of the external cutting member.

It is to be understood that a practically allowable minimum value for the ratio of said first radial distance and said second radial distance may be dependent on the cutting-edge angle, in particular in a preferred embodiment of the hair-cutting unit according to the invention wherein the cutting edge of each cutting element of the internal cutting member extends as a continuous curved line from a radial position at or near the radially inner slot-end position to a radial position at or near the radially outer slot-end position. In particular, in this preferred embodiment, a relatively large cutting-edge angle may result in a relatively high value for said ratio, i.e., a relatively short radial extension of the hair-entry slots, while smaller values of the cutting-edge angle may allow a smaller value of said ratio, i.e., a larger radial extension of the hair-entry slots. In this preferred embodiment, a number N of the cutting elements of the internal cutting member may be in a range from 2 to 6, preferably 3 or 4, and the cutting edge of each cutting element may extend over an angle of 360°/N about the central axis.

In a further embodiment of the hair-cutting unit according to the invention, the cutting edges of the cutting elements of the internal cutting member each have, relative to the central axis, a radially inner edge-end position which is closer to the central axis than the radially inner slot-end position of each of the hair-entry slots. As a result, during rotation of the internal cutting member, the skin of the user is not exposed via the hair-entry slots to the radially inner edge-end positions of the cutting edges, which are leading the cutting edges in the rotational direction of the internal cutting member. In particular, the radially inner edge-end positions of the cutting edges of the internal cutting member are always covered by a central skin-contacting surface of the external cutting member. Thus, skin irritation by contact of the skin with the leading radially inner edge-end positions is prevented.

To further improve the hair-catching performance of the hair-entry slots, in a further embodiment of the hair-cutting unit according to the invention the hair-entry slots are open in a radially outward direction at the radially outer slot-end positions.

A shaving unit according to the invention has at least one hair-cutting unit according to any of the embodiments as described here before, and further has a supporting structure configured to support the at least one hair-cutting unit.

A shaving device according to the invention has a main housing and a shaving unit according to the invention as described here before, wherein the shaving unit is coupled to the main housing and the main housing accommodates a driving system configured to drive the internal cutting member of each hair-cutting unit of the shaving unit into rotation relative to the external cutting member.

The above-described and other aspects of the invention will be apparent from and elucidated with reference to the following detailed description of embodiments of a hair-cutting unit, a shaving unit and a shaving device in accordance with the invention.

### BRIEF DESCRIPTION OF THE DRAWINGS

The invention will be explained in greater detail with reference to the figures, in which equal or similar features are indicated by the same reference signs, and in which:

FIG. 1 shows an embodiment of a shaving device according to the invention;

FIG. 2 shows an embodiment of a shaving unit according to the invention comprised by the shaving device of FIG. 1;

FIG. 3 shows an embodiment of a hair-cutting unit according to the invention comprised by the shaving unit of FIG. 2;

FIG. 4 shows a drive spindle of a driving system of the shaving device of FIG. 1 in driving engagement with the hair-cutting unit of FIG. 3;

FIG. 5 shows an external cutting member of the hair-cutting unit of FIG. 3;

FIG. 6 shows an internal cutting member of the hair-cutting unit of FIG. 3;

FIG. 7 shows part of a hair-entry slot of the external cutting member of FIG. 5 and part of a cutting element of the internal cutting member of FIG. 6;

FIG. 8 shows in detail a slicing motion of the cutting edge of the cutting element shown in FIG. 7 through a hair held in position by a hair-retaining structure of the hair-entry slot shown in FIG. 7; and

FIG. 9 shows an external cutting member of a second embodiment of a hair-cutting unit according to the invention;

### DETAILED DESCRIPTION OF THE EMBODIMENTS

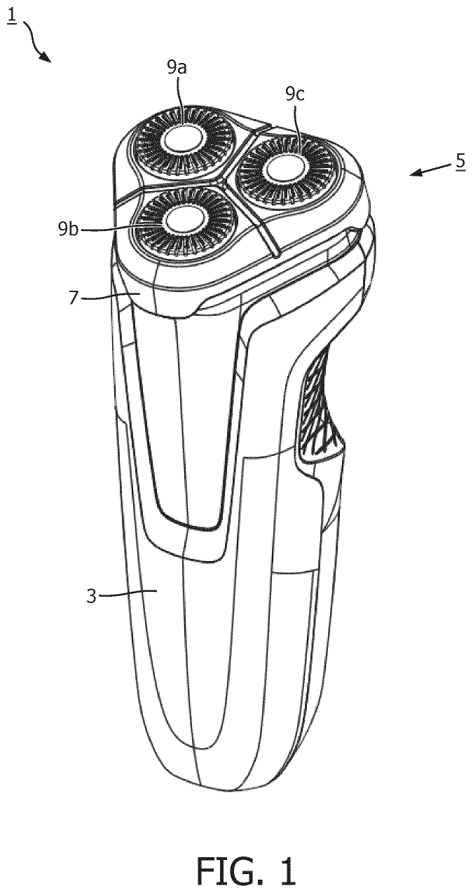

FIG. 1 shows an embodiment of a shaving device 1 according to the invention. The shaving device 1 comprises a main housing 3 designed to be held by a user's hand during operation. The shaving device 1 further comprises a shaving unit 5 according to the invention which is coupled to the main housing 3. The shaving unit 5 comprises a supporting structure 7 and three hair-cutting units 9a, 9b, 9c according to the invention. The supporting structure 7 is configured to support the three hair-cutting units 9a, 9b, 9c. The supporting structure 7 may comprise a coupling structure, not shown in the figures and of a kind well known to the skilled person, by means of which the shaving unit 5 is releasably coupled to the main housing 3. Alternatively, the shaving unit 5 may be permanently connected to the main housing 3. It is noted that a shaving unit according to the invention may comprise a different number of hair-cutting units according to the invention, for example one, two or more than three hair-cutting units.

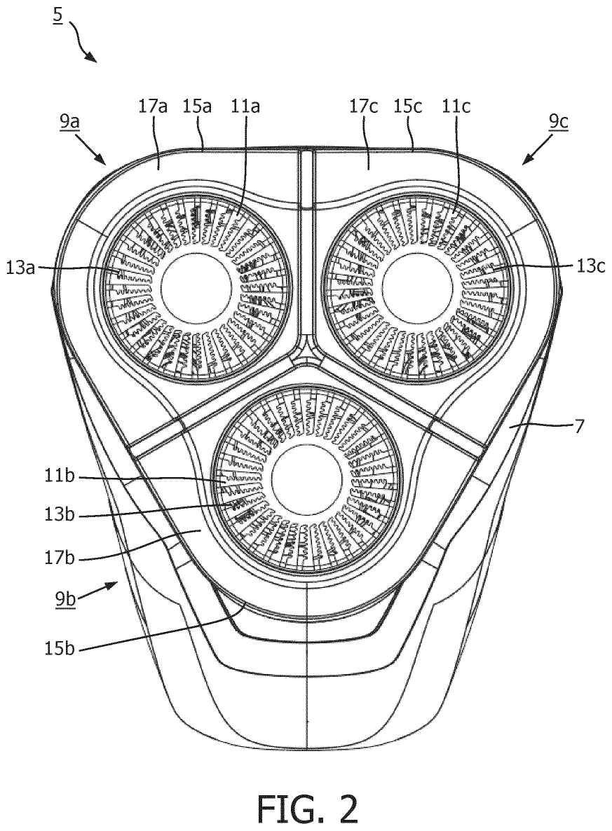

FIG. 2 shows the shaving unit 5 in a top view. The three hair-cutting units 9a, 9b, 9c are arranged in a triangular configuration and each comprise an external cutting member 11a, 11b, 11c and an internal cutting member 13a, 13b, 13c which is covered by the external cutting member 11a, 11b, 11c and, therefore, is only partially visible in FIG. 2. Furthermore, the hair-cutting units 9a, 9b, 9c each comprise a supporting member 15a, 15b, 15c, which is configured to support the respective external cutting member 11a, 11b, 11c and the respective internal cutting member 13a, 13b, 13c and which comprises a skin-contacting surface 17a, 17b, 17c surrounding the respective external cutting member 11a, 11b, 11c. The supporting members 15a, 15b, 15c may be mutually pivotal in a manner known to the skilled person, so that the orientations of the external cutting members 11a, 11b, 11c and the skin-contacting surfaces 17a, 17b, 17c of the supporting members 15a, 15b, 15c may be adjusted to the local contours of the skin of the user during use of the shaving device 1.

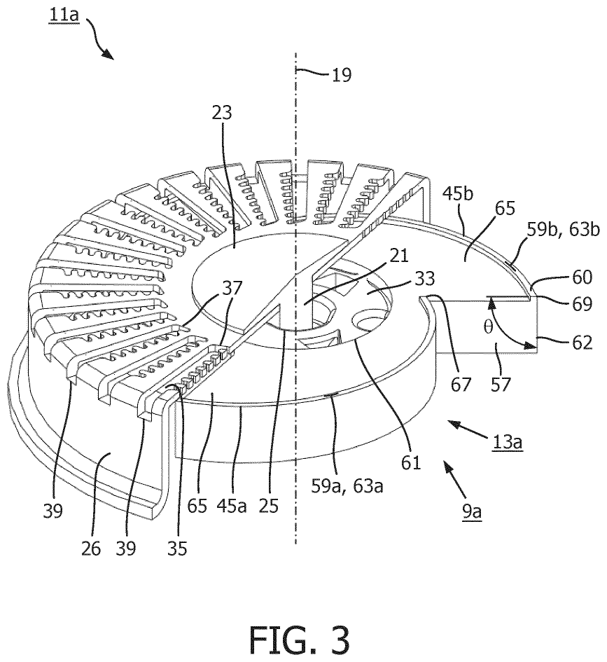

FIG. 3 shows the external cutting member 11a and the internal cutting member 13a of the hair-cutting unit 9a in more detail, wherein only half of the external cutting member 11a is shown so that the internal cutting member 13a (covered by the external cutting member 11a) is visible to a larger extent. The hair-cutting units 9b and 9c are identical to the hair-cutting unit 9a. The hair-cutting unit 9a comprises a central axis 19, and the internal cutting member 13a is rotatable relative to the external cutting member 11a about the central axis 19. For this purpose, the external cutting member 11a comprises a cylindrical bearing pin 21, which is arranged coaxially relative to the central axis 19 on an inner side of an upper wall 23 of the external cutting member 11a. The internal cutting member 13a comprises a bearing bush 25 which receives the bearing pin 21 of the external cutting member 11a. The external cutting member 11a further comprises a cylindrical wall 26 that connects to a circumference of the upper wall 23. The upper wall 23 and the cylindrical wall 26 together result in the external cutting member 11a to be cup-shaped and covering the internal cutting member 13a.

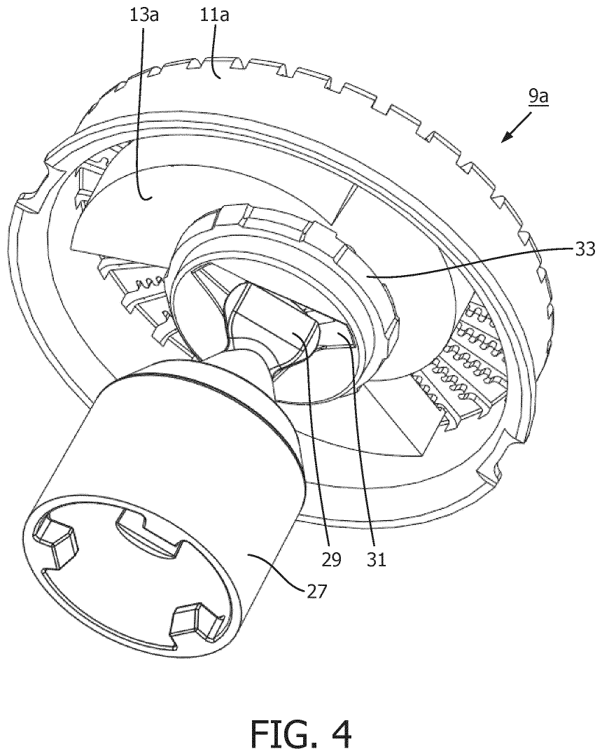

The shaving device 1 comprises a driving system which is configured to drive the internal cutting member 13a, 13b, 13c of each hair-cutting unit 9a, 9b, 9c of the shaving unit 5 into rotation relative to the respective external cutting member 11a, 11b, 11c. The driving system is not visible in FIG. 1 and may be of a kind which is known to the skilled person. In particular, the driving system may comprise an electric motor arranged in the main housing 3, three rotatable drive spindles arranged in the supporting structure 7 of the shaving unit 5 and each being coupled to a respective one of the internal cutting members 13a, 13b, 13c, and a transmission system arranged in the main housing 3 and in the supporting structure 7 of the shaving unit 5 via which the electric motor can drive the three drive spindles into rotation. FIG. 4 shows one of the drive spindles 27 of the driving system, which is in driving engagement with the internal cutting member 13a of the hair-cutting unit 9a, The drive spindle 27 comprises a coupling head 29 which engages a coupling cavity 31 of the internal cutting member 13a. The coupling cavity 31 is provided on a carrier 33 of the internal cutting member 13a, which is centrally arranged on the internal cutting member 13a. The carrier 33 also comprises the bearing bush 25 of the internal cutting member 13a described here before.

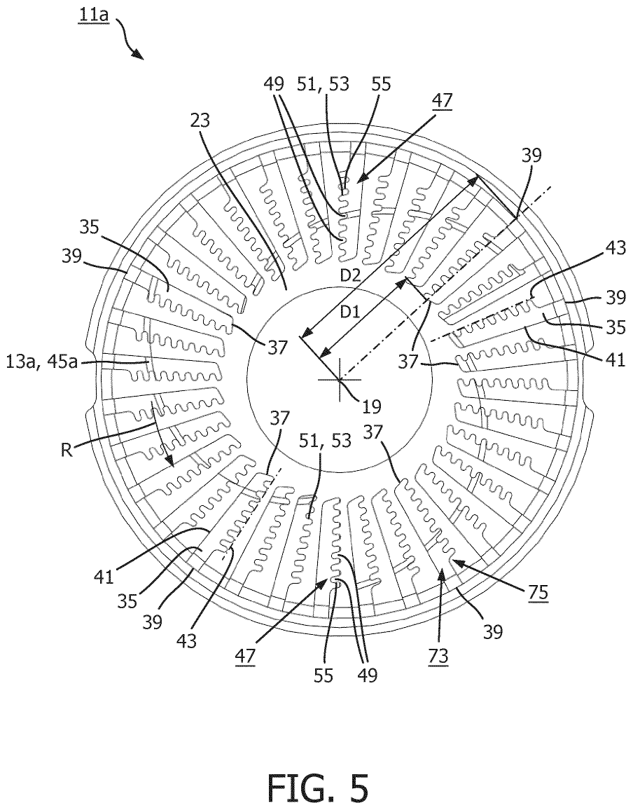

FIG. 5 shows the external cutting member 11a of the hair-cutting unit 9a in a top view, i.e., seen in an axial direction parallel to the central axis 19. The upper wall 23 of the external cutting member 11a comprises a plurality of hair-entry slots 35 that each extend, relative to the central axis 19. from a radially inner slot-end position 37 to a radially outer slot-end position 39 along a longitudinal extension of the hair-entry slot. The radially inner slot-end position is, relative to the central axis 19, the radially innermost point of the hair-entry slot 35, while the radially outer slot-end position is, relative to the central axis 19, the radially outermost point of the hair-entry slot 35, seen in the axial direction. In the embodiment shown in FIG. 5, the external cutting member 11a has 32 hair-entry slots 35 that are arranged at equal mutual distances about the central axis 19. Alternatively, the external cutting member may have a different number of hair-entry slots, and the hair-entry slots may be irregularly distributed about the central axis 19. In the embodiment shown in FIG. 5, the inner slot-end positions 37 of the hair-entry slots 35 are at equal distances from the central axis 19, but alternatively the inner slot-end positions 37 may be at mutually different distances from the central axis 19. Similarly, in the embodiment shown in FIG. 5 the outer slot-end positions 39 of the hair-entry slots 35 are at equal distances from the central axis 19, but alternatively the outer slot-end positions 39 may be at mutually different distances from the central axis 19.

As shown in FIG. 5, a leading edge 41 and a trailing edge 43 of each hair-entry slot 35 both extend along the longitudinal extension of the hair-entry slot 35 and are both defined relative to a rotational direction of the internal cutting member 13a, which is indicated by the arrow R. I.e., when during rotation of the internal cutting member 13a in the rotational direction R a particular portion of the internal cutting member 13a, in particular a cutting edge 45a of the internal cutting member 13a that will be described in more detail in the following, passes a hair-entry slot 35, said particular portion will first pass the leading edge 41 of the hair-entry slot 35 and will subsequently pass the trailing edge 43 of the hair-entry slot 35. Seen in the axial direction as shown in FIG. 5, a slot angle α of each hair-entry slot 35 is defined as a sharp angle enclosed by the trailing edge 43 of the hair-entry slot 35 and a local radial direction, relative to the central axis 19, at the trailing edge 43. Because in the embodiment of FIG. 5 the trailing edges 43 extend in a radial direction relative to the central axis 19, the slot angle α of the hair-entry slots 35 is 0°. According to the invention, the slot angle α of each hair-entry slot 35 along the longitudinal extension of the hair-entry slot 35 is in a range from 0° to 20° in each radial position of the hair-entry slot 35 between the radially inner slot-end position 37 and the radially outer slot-end position 39. The slot angle α may be identical in each radial position of the hair-entry slot 35. Alternatively, the slot angle α is different in different radial positions of the hair-entry slot 35. The trailing edges 43 of the hair-entry slots 35 may be straight, such as in the embodiment of FIG. 5, but alternatively the trailing edges 43 may be slightly curved.

As further shown in FIG. 5, the trailing edge 43 of each hair-entry slot 35 of the external cutting member 11a is provided with a hair-retaining structure 47. In the embodiment shown in FIG. 5, the hair-retaining structure 47 comprises an array of tooth-like elements 49 arranged along the trailing edge 43 of each hair-entry slot 35. A first side-edge surface 51 of each of the tooth-like elements 49 facing the central axis 19 extends transversely relative to the trailing edge 43 and forms a hair-abutment surface 53 of the hair-retaining structure 47 functioning in a manner to be described in detail in the following. Thus, the hair-retaining structure 47 comprises an array of hair-abutment surfaces 53 arranged along the trailing edge 43, wherein each hair-abutment surface 53 extends transversely relative to the trailing edge 43 and faces the central axis 19. A second side-edge surface 55 of each tooth-like element 49 of the hair-retaining structure 47 faces away from the central axis 19 and extends substantially parallel to the first side-edge surface 51. The leading edge 41 of each hair-entry slot 35 extends as a straight line from the radially inner slot-end position 37 to the radially outer slot-end position 39 at a distance from the tooth-like elements 49 of the hair-retaining structure 47 at the trailing edge 43. Furthermore, as is best visible in FIG. 3, the hair-entry slots 35 are open in a radially outward direction at the radially outer slot-end positions 39.

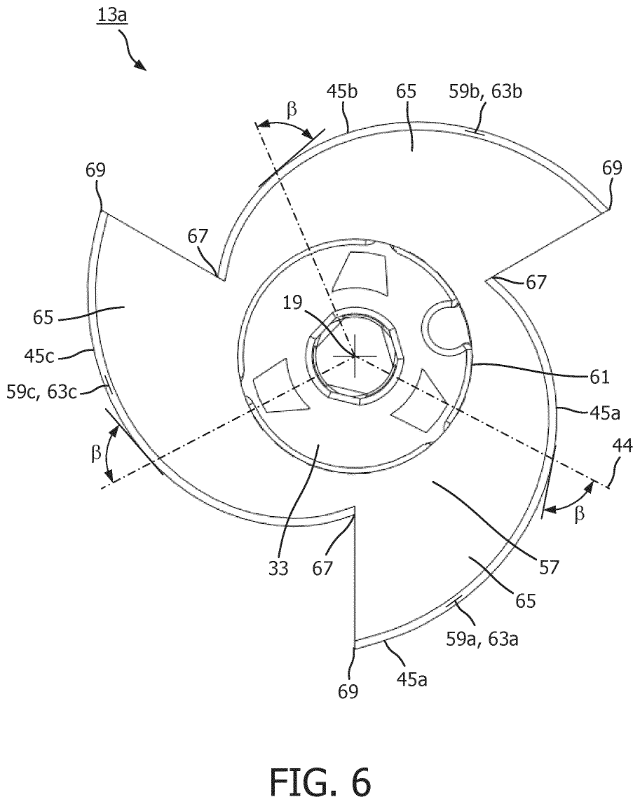

FIG. 6 shows the internal cutting member 13a of the hair-cutting unit 9a in a top view, i.e., seen in the axial direction parallel to the central axis 19. As shown in FIG. 3 and FIG. 6, the internal cutting member 13a comprises a cutter body 57 which is provided with three cutting elements 59a, 59b, 59c, The cutter body 57 is fixed to the carrier 33 of the internal cutting member 13a that was described here before, wherein the carrier 33 is arranged in a central opening 61 of the cutter body 57. The cutting elements 59a, 59b, 59c are each formed as a ridge 63a, 63b, 63c that protrudes relative to an upper surface 65 of the cutter body 57. An upper circumferential edge of each ridge 63a, 63b, 63c forms a cutting edge 45a, 45b, 45c of the respective cutting element 59a, 59b, 59c. Each of the cutting edges 45a, 45b, 45c extends as a continuous curved line over an angle of 120° about the central axis 19 from a radially inner edge-end position 67 to a radially outer edge-end position 69. The radially inner edge-end positions 67 of the cutting edges 45a, 45b, 45c have a radial position, relative to the central axis 19, which is at or near the radial position of the radially inner slot-end positions 37 of the hair-entry slots 35. The radially outer edge-end positions 69 of the cutting edges 45a, 45b, 45c have a radial position, relative to the central axis 19, which is near the radial position of the radially outer slot-end positions 39 of the hair-entry slots 35. Seen in the axial direction as shown in FIG. 6, a cutting-edge angle β of each cutting edge 45a, 45b, 45c is defined as a sharp angle enclosed by the cutting edge 45a, 45b, 45c and a local radial direction 44, relative to the central axis 19, at said cutting edge 45a, 45b, 45c, According to the invention, the cutting-edge angle β is in a range from 55° to 85° in any position on the cutting edges 45a, 45b, 45c.

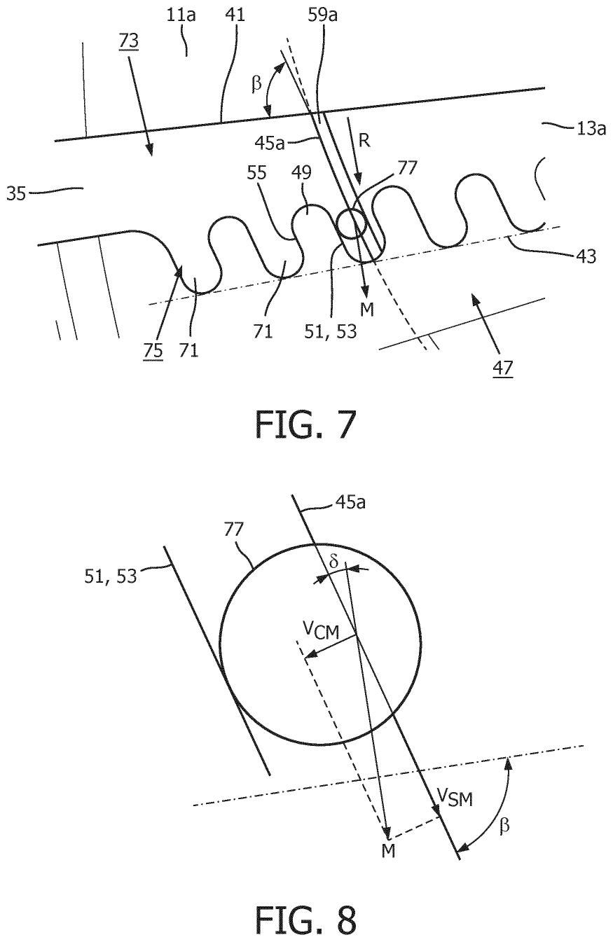

FIG. 7 shows part of a hair-entry slot 35 of the external cutting member 11a and part of the cutting element 59a of the internal cutting member 13a when the cutting edge 45a of the cutting element 59a passes the hair-entry slot 35 during operation of the shaving device 1. Seen in the axial direction parallel to the central axis 19 as in FIG. 7, a shearing angle γ enclosed by a hair-abutment surface 53 of a tooth-like element 49 of the hair-retaining structure 47 and the cutting edge 45a, when present at said hair-abutment surface 53, is 0° in the embodiment shown in FIG. 7. In other words, as shown in FIG. 7, at the location of the tooth-like element 49 the hair-abutment surface 53 extends parallel to the cutting edge 45a. According to the invention, said shearing angle γ is in a range from 0° to 15°.

During operation of the shaving device 1 the internal cutting members 13a, 13b, 13c are rotating relative to the external cutting members 11a, 11b, 11c, In the following, the operation of the shaving device 1 will be described with reference to the hair-cutting unit 9a having the external cutting member 11a and the internal cutting member 13a, The operation of the hair-cutting units 9b and 9c is similar. During operation, the cutting edges 45a, 45b, 45c make a sliding motion along the inner side of the angular section of the upper wall 23 of the external cutting member 11a wherein the hair-entry slots 35 are provided. Because the cutting edges 45a, 45b, 45c are provided on the narrow ridges 63a, 63b, 63c that protrude relative to the upper surface 65 of the cutter body 57, an optimum sliding contact is achieved between the cutting edges 45a, 45b, 45c and the inner side of said angular section of the upper wall 23 of the external cutting member 11a.

During operation, hairs on the user's skin will penetrate into the hair-entry slots 35 of the external cutting member 11a. The relatively small slot angle α of the hair-entry slots 35 in the range from 0° to 20° results in a high hair-catching performance of the hair-cutting unit 9a, i.e., a high ability of the hair-entry slots 35 to receive hairs. With respect to said hair-catching performance, a preferred range for the slot angle α of the hair-entry slots 35 is from 0° to 5°. The hair-catching performance is further increased as a result of the fact that the hair-entry slots 35 are open in the radially outward direction at the radially outer slot-end positions 39, as shown in FIG. 3.

A hair that penetrates into one of the hair-entry slots 35 will be manipulated by one of the cutting elements 59a, 59b, 59c of the rotating internal cutting member 13a into one of the spaces 71 that are present between the pairs of adjacent tooth-like elements 49 of the hair-retaining structure 47 at the trailing edge 43 of the hair-entry slot 35. This hair manipulation is the result of the fact that the cutting elements 59a, 59b, 59c move from the leading edge 41 towards the trailing edge 43 of the hair-entry slot 35. combined with the fact that the cutting-edge angle β of the cutting edges 45a, 45b, 45c is smaller than 85°. After being manipulated into one of the spaces 71 of the hair-retaining structure 47, the hair will be manipulated into a position in abutment with the hair-abutment surface 53 of the tooth-like element 49 bounding the space 71. The hair-abutment surface 53 will prevent further manipulation of the hair in the hair-entry slot 35 by the cutting element 59a, 59b, 59c during the subsequent hair-cutting process, in particular as a result of the friction between the hair and the hair-abutment surface 53.

As shown in FIG. 5 and FIG. 7, the hair-entry slots 35 have a first area 73 that extends as a continuous open slot area along the leading edge 41 from the radially outer slot-end position 39 to the radially inner slot-end position 37, and a second area 75 along the trailing edge 43 wherein the array of tooth-like elements 49 of the hair-retaining structure 47 is arranged. In this embodiment, hairs may be effectively caught initially in said first areas 73 of the hair-entry slots 35 and may subsequently be efficiently manipulated by the cutting elements 59a, 59b, 59c of the rotating internal cutting member 13a into said second areas 75 of the hair-entry slots 35 and into abutment with the hair-abutment surfaces 53 of the hair-retaining structure 47.

As a result of the relatively large cutting-edge angle β of the cutting edges 45a, 45b, 45c, the cutting edges 45a, 45b, 45c of the rotating internal cutting member 13a will make slicing motions through the hairs during the hair-cutting process, with the hairs being held in stationary positions in abutment with the hair-abutment surfaces 53 of the hair-retaining structure 47. Said slicing motion is schematically illustrated in FIG. 7, which shows the cutting edge 45a and a hair 77 held in position by the hair-retaining structure 47 and partially cut by the cutting edge 45a. The slicing motion of the cutting edge 45a through the hair 77 is shown in detail in FIG. 8. The local movement direction of the cutting edge 45a through the hair 77 is illustrated by the arrow M in FIG. 7 and FIG. 8, which is tangentially relative to the central axis 19. The sharp angle δ enclosed by the cutting edge 45a and the arrow M at the location of the hair 77 is equal to 90°-β. Because the angle δ is relatively small, a local velocity of the cutting edge 45a through the hair 77 in a direction parallel to the cutting edge 45a (i.e., the slicing motion velocity V_{SM} shown in FIG. 8) is much larger than a local velocity of the cutting edge 45a through the hair 77 in a direction perpendicular to the cutting edge 45a (i.e., the chopping motion velocity V_{CM} as shown in FIG. 8). Said relatively high slicing motion velocity V_{SM} of the cutting edge 45a through the hair 77 results in an improved hair-cutting performance as compared with hair-cutting units wherein the hair-entry slots of the external cutting member and the cutting edges of the internal cutting member both have a main direction of extension in the radial direction relative to the central axis and wherein, as a consequence, the cutting edges make substantially only chopping motions through the hairs. Furthermore, as a result of said slicing motion of the cutting edges 45a, 45b, 45c through the hairs, the cutting process of a single hair is performed by a relatively large portion of a cutting edge 45a, 45b, 45c. This will result in a relatively low degree of wear of the cutting edges 45a, 45b, 45c.

As described here before, the function of the hair-abutment surfaces 53 of the hair-retaining structure 47 is merely to maintain the hairs in a stationary position in the hair-entry slots 35 during the hair-cutting process. For this purpose, in the embodiment described here before, the shearing angle γ enclosed by each hair-abutment surface 53 and the cutting edge 45a, 45b, 45c when present at said hair-abutment surface 53 is 0°, i.e., the hair-abutment surfaces 53 each extend substantially parallel to the cutting edge 45a, 45b, 45c when present at the hair-abutment surface 53. In general, for an optimum maintenance of the hairs in a stationary position in the hair-entry slots 35 by the hair-abutment surfaces 53 of the hair-retaining structure 47 during the hair-cutting process, the shearing angle γ should be in a range from 0° to 15°. More preferably, the shearing angle γ is in a range from 0° to 5°. Because the hairs are effectively cut by only the slicing motion of the cutting edges 45a, 45b, 45c through the hairs as described here before, the trailing edge 43, the tooth-like elements 49 and in particular the hair-abutment surfaces 53 of the hair-retaining structure 47 do not need to be provided with counter cutting edges. The absence of any counter cutting edges on the external cutting members 11a, 11b, 11c simplifies the manufacturing process of the hair-cutting units 9a, 9b, 9c.

The relatively large cutting-edge angle β of the cutting edges 45a, 45b, 45c of the internal cutting members 13a, 13b, 13c limits the degree of skin irritation, in particular in combination with the presence of the hair-retaining structure 47 at the trailing edge 43 of the hair-entry slots 35. The limited degree of skin irritation allows a relatively large degree of skin doming into the hair-entry slots 35. Consequently, the hair-entry slots 35 may have a relatively large width. In particular, the first areas 73 of the hair-entry slots 35 may have a relatively large width in a direction perpendicular to the radial direction. This will further improve the hair-catching performance of the external cutting members 11a, 11b, 11c.

In the embodiment described here before, the cutting-edge angle β is 75°. It will be clear for the skilled person that the degree at which the motion of the cutting edges 45a, 45b, 45c through the hairs is a slicing motion will increase when the cutting-edge angle β increases. However, for cutting-edge angles close to 90° the motion component of the cutting edges 45a, 45b, 45c perpendicular to the cutting edges 45a, 45b, 45c is too small for an effective hair-cutting process. Therefore, the upper limit for the range of the cutting-edge angle β according to the invention is 85°. The lower limit for the range of the cutting-edge angle β according to the invention is 55°. For a cutting-edge angle β of 55°, the slicing motion component of the cutting edges 45a, 45b, 45c through the hairs (i.e., the motion component parallel to the cutting edges 45a, 45b, 45c) is still sufficiently large in order to achieve an effective hair-cutting process without requiring counter cutting edges at the external cutting members 11a, 11b, 11c. A preferred range of the cutting-edge angle β is from 70° to 80°. With the cutting-edge angle β being in this range, a particularly low degree of skin irritation is achieved, while cutting of the hairs by the slicing motion of the cutting edges through the hairs is very effective.

By the presence of the tooth-like elements 49, the hair-retaining structure 47 provided along the trailing edges 43 of the hair-entry slots 35 in the embodiment described here before has a comb-like structure. The comb-like structure results in an effective manipulation of the hairs by the cutting elements 59a, 59b, 59c of the rotating internal cutting members 13a, 13b, 13c into one of the spaces 71 that are present between the successive pairs of adjacent tooth-like elements 49. By providing a relatively large number of tooth-like elements 49 along the trailing edge 43, the hair-retaining performance of the hair-retaining structure 47 during the hair-cutting process may be improved. The second side-edge surface 55 of each tooth-like elements 49, that faces away from the central axis 19, may extend substantially parallel to the first side-edge surface 51, like in the embodiment described here before, or may extend non-parallel to the first side-edge surface 51.

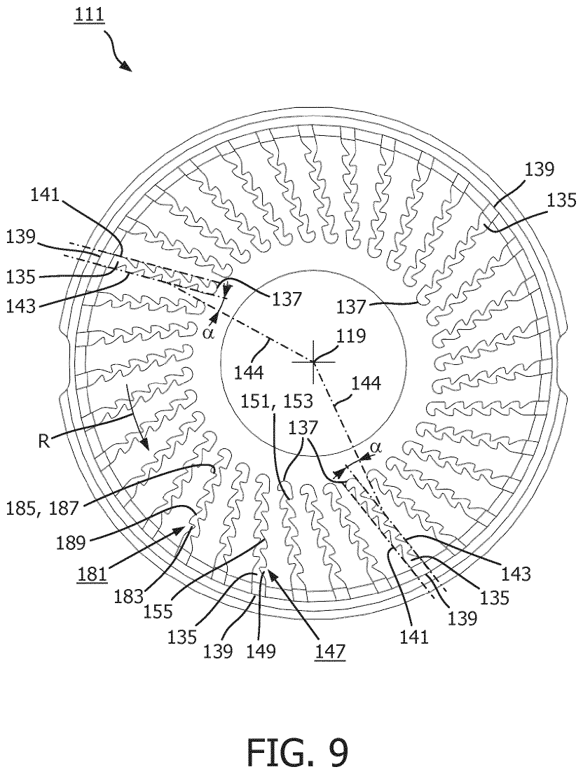

FIG. 9 shows, in a top view like in FIG. 5, an external cutting member 111 of a second embodiment of a hair-cutting unit according to the invention. In this second embodiment, the hair-cutting unit comprises an internal cutting member similar to the internal cutting member 13a of the hair-cutting unit 9a according to the embodiment described here before. The internal cutting member, which is not visible in FIG. 9, is covered by the external cutting member 111 and is rotatable relative to the external cutting member 111 about a central axis 119 of the hair-cutting unit. The external cutting member 111 comprises a plurality of hair-entry slots 135 that each extend, relative to the central axis 119, from a radially inner slot-end position 137 to a radially outer slot-end position 139 along a longitudinal extension of the hair-entry slot 135.

Similar to the embodiment of the external cutting member 11a of FIG. 5, the leading edge 141 and the trailing edge 143 of each hair-entry slot 135 of the external cutting member 111 of the second embodiment of the hair-cutting unit each extend along the longitudinal extension of the hair-entry slot 135 as a straight line with a main direction of extension in a radial direction relative to the central axis 119. However, different from the embodiment of the external cutting member 11a, the leading edges 141 and the trailing edges 143 of the external cutting member 111 do not extend exactly in radial directions. Consequently, as shown in FIG. 9, the hair-entry slots 135 each have a non-zero slot angle α enclosed by the trailing edge 143 of the hair-entry slot 135 and a local radial direction 144 relative to the central axis 119 at the trailing edge 143. Because the trailing edges 143 extend as non-radial straight lines, the slot angle α is different in different locations along the trailing edges 143, i.e., along the longitudinal extensions of the hair-entry slots 135. In particular, the slot angle α increases from a minimum value at the radially outer slot-end position 139 to a maximum value at the radially inner slot-end position 137 wherein, in accordance with the invention, the slot angle α along the longitudinal extension of the hair-entry slots 135 is at most 20° in each radial position of the hair-entry slots 135 between the radially inner slot-end position 137 and the radially outer slot-end position 139.

Similar to the embodiment of the external cutting member 11a of FIG. 5, the trailing edges 143 of the hair-entry slots 135 of the external cutting member 111 of the second embodiment of the hair-cutting unit are each provided with a hair-retaining structure 147 having an array of tooth-like elements 149 arranged along the trailing edge 143. A first side-edge surface 151 of each of the tooth-like elements 149 facing the central axis 119 extends transversely relative to the trailing edge 143 and forms a hair-abutment surface 153 of the hair-retaining structure 147. Thus, the hair-retaining structure 147 at the trailing edge 143 comprises an array of hair-abutment surfaces 153 arranged along the trailing edge 143, wherein each hair-abutment surface 153 extends transversely relative to the trailing edge 143 and faces the central axis 119. A second side-edge surface 155 of each tooth-like element 149 of the hair-retaining structure 147 at the trailing edge 143 faces away from the central axis 119 and extends obliquely to the first side-edge surface 151.

Different from the embodiment of the external cutting member 11a of FIG. 5, in the external cutting member 111 of the second embodiment of the hair-cutting unit also the leading edges 141 of the hair-entry slots 135 are each provided with a further hair-retaining structure 181 having an array of further tooth-like elements 183 arranged along the leading edge 141. Each further tooth-like element 183 has a first side-edge surface 185 that faces the central axis 119, extends transversely relative to the leading edge 141, and forms a further hair-abutment surface 187 of the further hair-retaining structure 181. Thus, the further hair-retaining structure 181 provided at the leading edge 141 comprises an array of further hair-abutment surfaces 187 arranged along the leading edge 141, wherein each further hair-abutment surface 187 extends transversely relative to the leading edge 141 and faces the central axis 119. A second side-edge surface 189 of each further tooth-like element 183 of the further hair-retaining structure 181 at the leading edge 141 faces away from the central axis 119 and extends obliquely to the first side-edge surface 185.

As shown in FIG. 9, the tooth-like elements 149 of the hair-retaining structure 147 arranged along the trailing edge 143 of the hair-entry slots 135 and the further tooth-like elements 183 of the further hair-retaining structure 181 arranged along the leading edge 141 of the hair-entry slots 135 are mutually arranged in a staggered configuration and, seen in the radial direction, in a partially overlapping configuration.

In the external cutting member 111 of the second embodiment of the hair-cutting unit. hairs may also be cut while being in abutment with the further hair-abutment surfaces 187 of the further tooth-like elements 183 of the further hair-retaining structure 181 provided along the leading edge 141 of the hair-entry slots 135. Although the presence of the further tooth-like elements 183 in the hair-entry slots 135 might slightly decrease the overall hair-catching performance of the hair-entry slots 135 as compared with the hair-entry slots 35 of the external cutting member 11a described here before, the overall hair-retaining performance of the hair-entry slots 135 during the hair-cutting process is improved by the presence of the further hair-retaining structure 181 as compared with the hair-entry slots 35 of the external cutting member 11a. As a result of the mutual arrangement of the tooth-like elements 149 of the hair-retaining structure 147 at the trailing edge 143 and the further tooth-like elements 183 of the further hair-retaining structure 181 at the leading edge 141 in a staggered configuration and, seen in the radial direction, in a partially overlapping configuration, an open slot area between the hair-retaining structure 147 at the trailing edge and the further hair-retaining structure 181 at the leading edge 141 extends zigzag-like from the radially outer slot-end position 139 to the radially inner slot-end position 137. This zigzag-like extension of said open slot area will significantly increase the overall hair-retaining performance of the hair-entry slots 135 during the hair-cutting process. To achieve an optimum hair-retaining performance during the hair-cutting process, a shearing angle enclosed by each hair-abutment surface 153 of the hair-retaining structure 147 and the cutting edge of each of the cutting elements of the internal cutting member should be in a range from 0° to 15°, preferably in a range from 0° to 5°.

Likewise, a further shearing angle enclosed by each further hair-abutment surface 187 of the further hair-retaining structure 181 and the cutting edge of each of the cutting elements of the internal cutting member should be in a range from 0° to 15°. preferably in a range from 0° to 5°. In the embodiment shown in FIG. 11, both said shearing angle and said further shearing angle are 0°.

In the embodiment of the external cutting member 11a shown in FIG. 5, the hair-entry slots 35 have identical hair-retaining structures 47 arranged at their trailing edges 43, while in the embodiment of the external cutting member 111 shown in FIG. 9 the hair-entry slots 135 have identical hair-retaining structures 147 arranged at their trailing edges 143 and identical further hair-retaining structures 181 arranged at their leading edges 141. It is noted that the invention also covers hair-cutting units wherein the hair-entry slots of the external cutting member has mutually different hair-retaining structures arranged at different trailing edges and, when present, mutually different further hair-retaining structures arranged at different leading edges. An example of such an alternative external cutting member has both hair-entry slots of a kind similar to the hair-entry slots 35 of the external cutting member 11a shown in FIG. 5 and hair-entry slots of a kind similar to the hair-entry slots 135 of the external cutting member 111 shown in FIG. 9. In any embodiment, the hair-retaining structure at the trailing edge and the further hair-retaining structure (when present) at the leading edge has an array of hair-abutment surfaces arranged along the trailing edge and the leading edge, respectively, wherein each hair-abutment surface extends transversely relative to the trailing edge and the leading edge, respectively, and faces the central axis. Instead of being formed as side-edge surfaces provided on tooth-like elements of a comb-like structure, as is the case in the embodiments shown in FIG. 5 and FIG. 9, the hair-abutment surfaces may however also be provided in a different manner in the hair-retaining structure.

In FIG. 5. D1 indicates a first radial distance between the radially inner slot-end positions 37 of the hair-entry slots 35 and the central axis 19, and D2 indicates a second radial distance between the radially outer slot-end positions 39 of the hair-entry slots 35 and the central axis 19. In the embodiment of FIG. 5, a ratio D1/D2 is 0.5. Because the radially outer slot-end positions 39 of the hair-entry slots 35 are very close to an outer circumference of the external cutting member 11a, in this embodiment the hair-entry slots 35 extend over a significant part, i.e., about 50%, of the radius of the external cutting member 11a. This will result in a relatively high hair-catching performance of the hair-entry slots 35.

In the embodiment of the hair-cutting unit 9a, wherein the cutting edges 45a, 45b, 45c of the internal cutting member 13a each extend as a continuous curved line from the radially inner edge-end position 67 close to the radially inner slot-end positions 37 to the radially outer edge-end position 69 close to the radially outer slot-end positions 39, a practically allowable minimum value for the ratio D1/D2 depends on the value of the cutting-edge angle β of the cutting edges 45a, 45b, 45c, In particular, a relatively large cutting-edge angle β will result in a relatively short radial extension of the cutting edges of the internal cutting member and, as a result, in a relatively large first radial distance DI and a relatively high value of the ratio D1/D2. A relatively small cutting-edge angle β will allow a relatively long radial extension of the cutting edges of the internal cutting member and, as a result, will allow a relatively small first radial distance DI and a relatively low value of the ratio D1/D2. In general, for embodiments of a hair-cutting unit wherein the cutting edges of the internal cutting member extend as a continuous line as described with respect to the internal cutting member 13a here before, the ratio D1/D2 may be between 0.4 and 0.8. preferably between 0.5 and 0.6. This ratio implies that the hair-entry slots 35 extend over a radial distance of between about 20% and about 60% of the radius of the external cutting member 13a, and preferably between about 40% and about 50% of the radius of the external cutting member 13a.

The radially inner edge-end positions 67 of the cutting edges 45a, 45b, 45c have a radial position, relative to the central axis 19, which is closer to the central axis 19 than the radially inner slot-end positions 37 of the hair-entry slots 35 of the external cutting member 11a. As a result, the radially inner edge-end positions 67 of the cutting edges 45a, 45b, 45c of the internal cutting member 13a are always covered by a central closed portion of the upper wall 23 of the external cutting member 11a. Thus. during rotation of the internal cutting member 13a the skin of the user is not exposed at the radially inner slot-end positions 37 of the hair-entry slots 35 to the radially inner edge-end positions 67 of the cutting edges 45a, 45b, 45c, Because these radially inner edge-end positions 67 are leading the cutting edges 45a, 45b, 45c in the rotational direction R of the internal cutting member 13a, they could damage the skin if the skin were exposed to these radially inner edge-end positions 67. Because, as described here before and as shown in FIG. 6, each of the cutting edges 45a, 45b, 45c of the internal cutting member 13a extends as a continuous curved line from the radially inner edge-end position 67 to the radially outer edge-end position 69, the skin is not exposed to any leading edge-end points of any of the cutting edges 45a, 45b, 45c. Thus, skin irritation or skin damage by contact of the skin with the rotating cutting edges 45a, 45b, 45c is minimized, in particular also as a result of the relatively large cutting-edge angle β.

As described here before and as shown in FIG. 6, each of the three cutting edges 45a, 45b, 45c of the internal cutting member 13a extends over an angle of 120° about the central axis 19. It is noted that the internal cutting member may have a different number of cutting elements. In embodiments wherein the cutting edges each extend as a continuous curved line from the radially inner edge-end position to the radially outer edge-end position like in FIG. 6, the number N of cutting elements may depend on the cutting-edge angle β of the cutting edges, in particular when the cutting edges do not mutually overlap in the tangential direction about the central axis of the hair-cutting unit. In particular, the number N of cutting elements may be relatively large in case the cutting-edge angle β is relatively small. In this embodiment, in general the number N of cutting element of the internal cutting member may be in a range from 2 to 6, preferably 3 or 4. The cutting edge of each cutting element may extend over an angle of 360°/N about the central axis, like in the embodiment of FIG. 6. Alternatively, the cutting edges may extend about the central axis over mutually different angles and, consequently, the cutting edges may have mutually different radial extensions in case they have a similar cutting-edge angle β. In embodiments wherein the cutting edges do mutually overlap in the tangential direction about the central axis of the hair-cutting unit, the number N of cutting edges may be increased as compared with embodiments wherein the cutting edges do not mutually overlap in the tangential direction about the central axis.

It is noted that in the embodiment of the internal cutting member 13a as shown in FIG. 6 the cutting-edge angle β of each of the cutting edges 45a, 45b, 45c is equal in all positions on the cutting edge 45a, 45b, 45c between the radially inner edge-end position 67 and the radially outer edge-end position 69. This will require a particular curved shape of the cutting edge 45a, 45b, 45c between the radially inner edge-end positions 67 and the radially outer edge-end positions 69, which can be straight-forwardly designed by the skilled person. Alternatively, the cutting-edge angle β of the cutting edges 45a, 45b, 45c may vary along the cutting edges 45a, 45b, 45c, In that case, according to the invention the cutting-edge angle β should have a value within the range from 55° to 85° in each position on the cutting edge between the radially inner edge-end position and the radially outer edge-end position.

In the embodiment of FIG. 5, the plurality of hair-entry slots 35 arranged annularly about the central axis 19 may be considered as forming a single so-called shaving track of the hair-cutting unit 9a, Also the embodiment of the hair-cutting unit having the external cutting member 111 as shown in FIG. 9 has a single shaving track. It is noted that the invention also covers embodiments wherein the hair-cutting unit has two or more shaving tracks. In such embodiments, the external cutting member comprises two or more annular arrays of hair-entry slots arranged concentrically about the central axis, and the internal cutting member comprises two or more annular arrays of cutting elements with cutting edges arranged concentrically about the central axis. In such embodiments, the number of cutting elements in each individual shaving track may be larger than the number of cutting elements in embodiments with a single shaving track, in particular when the cutting-edge angle β is similar in all embodiments.

The cutting edges 45a, 45b, 45c of the internal cutting member 13a described here before have a wedge angle θ of about 90°. As shown in FIG. 3, the wedge angle θ is the angle enclosed by an upper surface 60 and a front surface 62 of the cutting element 59a, 59b, 59c at the location of the cutting edge 45a, 45b, 45c. The cutting forces needed to cut through hairs can be reduced by decreasing the wedge angle θ to a value smaller than 90°. This can be achieved by locally providing the front surface 62 with an oblique portion at the location of the cutting edge 45a, 45b, 45c, Alternatively, the entire front surface 62 can be arranged in an oblique orientation relative to the upper surface 60.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments. unless explicitly stated otherwise. Thus, the mere fact that certain measures are recited in mutually different dependent claims does not indicate that a combination of these measures cannot be used to advantage.

The terms “comprise” and “include” as used in the present text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

1. Hair-cutting unit comprising a central axis, an external cutting member and an internal cutting member which is covered by the external cutting member and rotatable relative to the external cutting member about the central axis, wherein:
the external cutting member comprises a plurality of hair-entry slots that each extend, relative to the central axis, from a radially inner slot-end position to a radially outer slot-end position along a longitudinal extension of the hair-entry slot:
the internal cutting member comprises a plurality of cutting elements that each have a cutting edge;
a slot angle of each hair-entry slot, when seen in an axial direction parallel to the central axis, is defined as a sharp angle enclosed by a trailing edge of the hair-entry slot, relative to a rotational direction of the internal cutting member and extending along the longitudinal extension of the hair-entry slot, and a local radial direction, relative to the central axis, at said trailing edge: and
a cutting-edge angle of each cutting edge, when seen in the axial direction, is defined as a sharp angle enclosed by the cutting edge and a local radial direction, relative to the central axis, at said cutting edge, said cutting-edge angle being in a range from 55° to 85°;
characterized in that:
the slot angle of each hair-entry slot along the longitudinal extension of the hair-entry slot is in a range from 0° to 20° in each radial position of the hair-entry slot between the radially inner slot-end position and the radially outer slot-end position; and
the trailing edge of each hair-entry slot is provided with a hair-retaining structure having an array of hair-abutment surfaces arranged along the trailing edge, each hair-abutment surface extending transversely relative to the trailing edge and facing the central axis.

2. Hair-cutting unit as claimed in claim 1, wherein a shearing angle enclosed by each hair-abutment surface, when seen in the axial direction, and the cutting edge of each of the cutting elements at said hair-abutment surface is in a range from 0° to 15°, preferably in a range from 0° to 5°.

3. Hair-cutting unit as claimed in claim 1, wherein the cutting-edge angle is in a range from 70° to 80°.

4. Hair-cutting unit as claimed in claim 1, wherein the slot angle is in a range from 0° to 5°.

5. Hair-cutting unit as claimed in claim 1, wherein the hair-retaining structure comprises an array of tooth-like elements arranged along the trailing edge of at least one of the hair-entry slots, wherein the hair-abutment surfaces are each formed by a first side-edge surface of a respective one of the tooth-like elements facing the central axis.

6. Hair-cutting unit as claimed in claim 5, wherein a second side-edge surface of each respective tooth-like element facing away from the central axis extends substantially parallel to the first side-edge surface of the respective tooth-like element.

7. Hair-cutting unit as claimed in claim 6, wherein a leading edge, relative to the rotational direction of the internal cutting member, of the hair-entry slot extends as a straight line from the radially inner slot-end position to the radially outer slot-end position at a distance from the tooth-like elements.

8. Hair-cutting unit as claimed in claim 5, wherein a leading edge, relative to the rotational direction of the internal cutting member, of the hair-entry slot comprises a further hair-retaining structure having an array of further tooth-like elements arranged along the leading edge, each further tooth-like element having a further hair-abutment surface formed by a side-edge surface of the further tooth-like element extending transversely relative to the leading edge and facing the central axis.

9. Hair-cutting unit as claimed in claim 8, wherein the tooth-like elements of the hair-retaining structure of the trailing edge of the hair-entry slot and the further tooth-like elements of the further hair-retaining structure of the leading edge of the hair-entry slot are mutually arranged in a staggered configuration and, seen in the radial direction, in a partially overlapping configuration.

10. Hair-cutting unit as claimed in claim 1. wherein a ratio of a first radial distance between the radially inner slot-end position and the central axis and a second radial distance between the radially outer slot-end position and the central axis is between 0.4 and 0.8, preferably between 0.5 and 0.6.

11. Hair-cutting unit as claimed in claim 1, wherein the cutting edge of each cutting element of the internal cutting member extends as a continuous curved line from a radial position at or near the radially inner slot-end position of each hair-entry slot to a radial position at or near the radially outer slot-end position of each hair-entry slot, and wherein a number of the cutting elements of the internal cutting member is in a range from 2 to 6, preferably 3 or 4.

12. Hair-cutting unit as claimed in claim 11, wherein the cutting edge of each cutting element of the internal cutting member extends over an angle of 360°/N about the central axis, wherein N is the number of the cutting elements of the internal cutting member.

13. Hair-cutting unit as claimed in claim 1, wherein the cutting edges of the cutting elements of the internal cutting member each have, relative to the central axis, a radially inner edge-end position which is closer to the central axis than the radially inner slot-end position of each of the hair-entry slots.

14. Hair-cutting unit as claimed in claim 1, wherein the hair-entry slots are open in a radially outward direction at the radially outer slot-end positions.

15. Shaving unit having at least one hair-cutting unit as claimed in claim 1 and further having a supporting structure configured to support the at least one hair-cutting unit.

16. Shaving device having a main housing and a shaving unit as claimed in claim 15, wherein the shaving unit is coupled to the main housing and the main housing accommodates a driving system configured to drive the internal cutting member of each hair-cutting unit of the shaving unit into rotation relative to the external cutting member.
